(19) United States
(12) Patent Application Publication
(10) Pub. No.: US 2024/0359631 A1
(43) Pub. Date: Oct. 31, 2024

(54) ATTACHMENT SYSTEM FOR HOLDING OR CARRYING ITEMS

(71) Applicant: THE TORO COMPANY, Bloomington, MN (US)

(72) Inventors: Adam W. Branscum, Charlotte, AR (US); Boyd Glen Wilson, Bradford, AR (US); Gustavo Perez Muñoz, Judsonia, AR (US)

(21) Appl. No.: 18/632,922

(22) Filed: Apr. 11, 2024

Related U.S. Application Data
(60) Provisional application No. 63/462,039, filed on Apr. 26, 2023.

(51) Int. Cl. B60R 9/02; A01D 34/64; A01D 75/00; A01D 101/00

(52) U.S. Cl. CPC B60R 9/02; A01D 75/008; A01D 34/64; A01D 2101/00

(57) ABSTRACT

An attachment system for carrying or holding an item such as a tool. The attachment system may include one or more receivers that receive and hold the item. The attachment system may also include an elastic member associated with each receiver, wherein the elastic member may deform or deflect during insertion of the item into the receiver and ultimately secure the item in place.

### CROSS-REFERENCE TO RELATED APPLICATIONS

The present application claims the benefit under 35 U.S.C. § 119 (e) of U.S. Provisional Patent Application Ser. No. 63/462,039, filed Apr. 26, 2023, entitled ATTACHMENT SYSTEM FOR HOLDING OR CARRYING ITEMS, which is hereby incorporated by reference in its entirety.

### FIELD

Embodiments of the present disclosure are directed generally to attachment systems for holding or carrying items (e.g., tools).

### BACKGROUND

Utility vehicles such as riding lawn mowers and the like are known to include mounts or platforms configured to receive and carry tools during vehicle operation. These mounts typically require various locks, latches, straps, and/or other multi-step engagement features in order to secure the tool to the mount/platform.

### SUMMARY

Embodiments of the present disclosure may address these and other issues by providing, in one embodiment, an attachment system configured to carry an item on a utility vehicle. The attachment system includes at least one receiver. The receiver includes a body having a peripheral outer edge and inner sidewalls. The inner sidewalls define a slot that extends from an interior of the body through the outer edge. The slot defines a mouth extending through the outer edge, a seat configured to receive the item when the item is carried by the utility vehicle, and a throat extending between and connecting the mouth and the seat. The attachment system further includes at least one elastic member. The elastic member includes a first end and a second end. The first and second ends are coupled to the body and the elastic member extends across the mouth. The elastic member is configured to releasably secure the item within the seat.

In another embodiment, a utility vehicle is provided that includes a chassis and wheels, the wheels configured to support the chassis in rolling engagement with a ground surface. The utility vehicle further includes an attachment system configured to carry an item on the utility vehicle. The attachment system includes at least one receiver secured to the chassis, the receiver having a body with a peripheral outer edge and inner sidewalls. The inner sidewalls define a slot that extends from an interior of the body through the outer edge. The slot further defines a mouth extending through the outer edge, a seat configured to receive the item when the item is carried by the utility vehicle, and a throat extending between and connecting the mouth and the seat. The attachment system further includes at least one elastic member having a first end and a second end that are coupled to the body such that the elastic member extends across the mouth. The elastic member is configured to releasably secure the item within the seat.

In yet another embodiment, a method is provided for moving an item from a detached position to a secured position within a receiver. The method includes inserting the item into a mouth of a slot formed in the receiver. The method further includes advancing the item into a throat of the slot, and positioning the item within a seat of the slot. An elastic member is coupled to the receiver and extends across the mouth and the seat. The elastic member is configured to elongate as the item moves into the throat of the slot, and contract as the item moves into the seat.

The above summary is not intended to describe each embodiment or every implementation. Rather, a more complete understanding of illustrative embodiments will become apparent and appreciated by reference to the following Detailed Description of Exemplary Embodiments and claims in view of the accompanying figures of the Drawing.

### BRIEF DESCRIPTION OF THE VIEWS OF THE DRAWING

Exemplary embodiments will be further described with reference to the figures of the drawing, wherein:

FIG. 1 is a front perspective view of a utility vehicle (e.g., riding lawn mower) incorporating an attachment system in accordance with embodiments of the present disclosure;

FIG. 2 is a rear perspective view of the mower of FIG. 1;

FIG. 3 is a perspective view of an item (e.g., string trimmer) and an isolated portion of an attachment system in accordance with embodiments of the present disclosure;

FIG. 4 illustrates a receiver of the exemplary attachment system of FIGS. 1-2;

FIG. 5 is an enlarged view of a portion of the receiver of FIG. 4;

FIGS. 6A-6C illustrate the exemplary receiver of FIGS. 4-5 during receipt of an item, wherein: FIG. 6A illustrates introduction of the item into the receiver; FIG. 6B illustrates the item partially inserted into the receiver; and FIG. 6C illustrates the item once it is secured within the receiver;

FIG. 7 is an enlarged view of a receiver according to another embodiment of the present disclosure; and

FIG. 8 is an enlarged view of a receiver according to yet another embodiment of the present disclosure.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION OF EXEMPLARY EMBODIMENTS

In the following detailed description of illustrative embodiments, reference is made to the accompanying figures of the drawing which form a part hereof. It is to be understood that other embodiments, which may not be described and/or illustrated herein, are certainly contemplated.

All headings provided herein are for the convenience of the reader and should not be used to limit the meaning of any text that follows the heading, unless so specified. Moreover, unless otherwise indicated, all numbers expressing quantities, and all terms expressing direction/orientation (e.g., vertical, horizontal, parallel, perpendicular, etc.) in the specification and claims are to be understood as being modified in all instances by the term “about.” The term “and/or” (if used) means one or all of the listed elements or a combination of any two or more of the listed elements. The term “i.e.” is used as an abbreviation for the Latin phrase id est and means “that is.” The term “e.g.” is used as an abbreviation for the Latin phrase exempli gratia and means “for example.”

Embodiments of the present disclosure may provide an attachment system for receiving and releasably securing various items to a vehicle without the need for tools or positive retention or other multi-step mechanisms (e.g., snaps, latches, etc.). Rather, the item may be secured in place merely by inserting the item into a receiver of the attachment system.

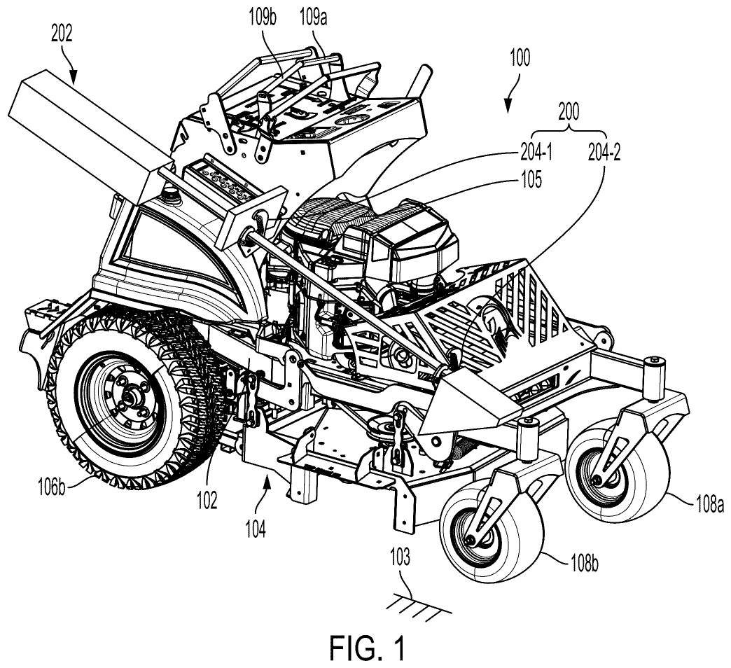

It is noted that the terms “have,” “include,” “comprise,” and variations thereof, do not have a limiting meaning, and are used in their open-ended sense to generally mean “including, but not limited to,” where the terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective shown in the particular figure, or while the vehicle 100 is in an operating configuration (e.g., while the vehicle 100 is positioned such that wheels 106 and 108 rest upon a generally horizontal ground surface 103 as shown in FIG. 1). These terms are used only to simplify the description, however, and not to limit the interpretation of any embodiment described. In a similar manner, terms such as “first” and “second” may be used herein to describe various elements. However, such terms are provided merely to simplify identification of the element(s). Accordingly, if an element is described as “first,” there may or may not be any other subsequent elements—that is, a “second” element is not necessarily present. It is further understood that the description of any particular element as being operatively attached, connected, and/or coupled to another element may indicate that the elements are either directly attached, connected, and/or coupled to one another, or are indirectly attached, coupled, and/or connected to one another via intervening elements.

Still further, the suffixes “a” and “b” may be used throughout this description to denote various left- and right-side parts/features, respectively. However, in most pertinent respects, the parts/features denoted with “a” and “b” suffixes are generally identical to, or mirror images of, one another. It is understood that, unless otherwise noted, the description of an individual part/feature (e.g., part/feature identified with an “a” suffix) also applies to the opposing part/feature (e.g., part/feature identified with a “b” suffix). Similarly, the description of a part/feature identified with no suffix may apply, unless noted otherwise, to both the corresponding left and right part/feature, either individually or collectively.

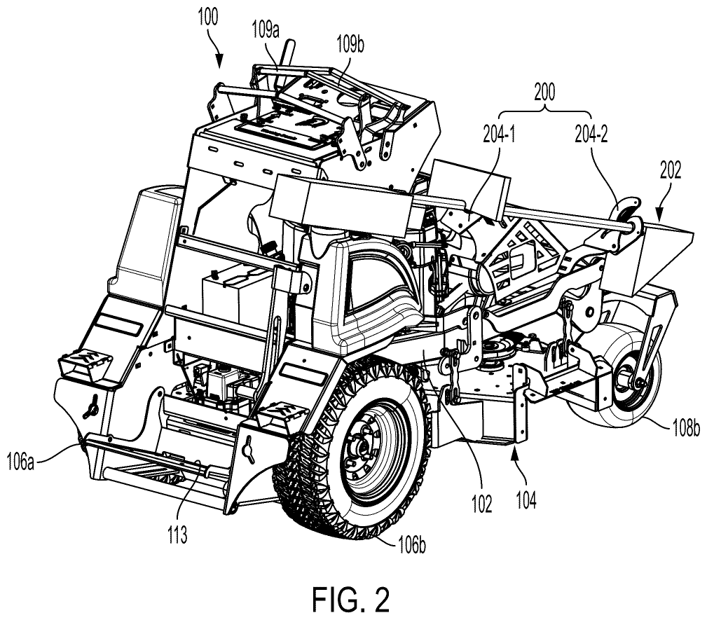

With reference to the figures of the drawing, wherein like reference numerals designate like parts and assemblies throughout the several views, FIGS. 1-2 illustrate a utility vehicle 100. For illustrative purposes, the utility vehicle is described and illustrated herein as a ride-on lawn mower. However, it is to be understood that the term “utility vehicle” may include most any ground maintenance or work vehicle including, for example, walk-behind, ride-behind (e.g., such as vehicles utilizing sulkies), and ride-on (sit-on and/or and stand-on) vehicles such as mowers, sports field groomers, treatment (e.g., fertilizing, spraying, misting, etc.) vehicles, aerators, snow throwers, tillers, trenchers, skid-steer loaders, compact utility loaders, horizontal directional drills, agricultural vehicles, indoor and/or outdoor demolition and construction vehicles and the like, as well as to recreational vehicles such as saddle-type all-terrain vehicles (ATVs) and side-by-side utility task vehicles (UTVs), and to road and off-road equipment trailers. In fact, attachments systems in accordance with embodiments of the present disclosure may find application to most any vehicle in which the carrying of other (e.g., hand-held) equipment is advantageous, including autonomous or remotely-controlled vehicles. For purposes of this description, the terms “mower,” “utility vehicle,” and “vehicle” may be used interchangeably herein without limitation.

As shown in FIGS. 1-2, the vehicle 100 may include a frame or chassis 102 having a front end and a rear end, the chassis 102 supporting a power source or prime mover such as one or more internal combustion engines 105 and/or one or more electric motors and battery packs. For example, one engine could power both a cutting deck 104 and a vehicle propulsion system (not shown). In other embodiments, multiple electric motors could be used to separately power the cutting deck (e.g., one electric motor powering multiple blade spindles, or a separate motor powering each individual spindle) and the propulsion system (e.g., one motor powering a single transaxle, or separate motors powering each drive wheel (or axle) independently).

A pair of ground-engaging drive members, e.g., first and second drive wheels 106 (e.g., left rear drive wheel 106a and a right rear drive wheel 106b), may be coupled to left and right rear sides of the chassis 102 to support the vehicle 100 upon, and propel the vehicle 100 relative to, the ground surface 103.

Operator controls may permit independent control of the speed and direction of each drive wheel 106, allowing operator control of vehicle speed and direction from an operator position. The operator position may include an operator seat (not shown) or operator standing platform 113 (see FIG. 2). In alternate embodiments, the standing platform 113 could be folded and stored against the rear of the vehicle 100 to permit walk-behind operation of the vehicle using the same controls used for stand-on operation. While not wishing to be bound to any specific embodiment, the operator controls may include drive control levers 109 (e.g., a left drive control lever 109a and a right drive control lever 109b) as illustrated. The drive control levers 109 may be configured to independently and proportionally control rotational speed and direction of their respective drive wheels 106 via manipulation of the vehicle's propulsion system as is known in the art. While illustrated herein as incorporating separate drive control levers 109, other controls, e.g., single or multiple joysticks or joystick-type levers, steering wheels, touchscreens, etc. may also be used to control mower speed and direction without departing from the scope of this disclosure. The vehicle 100 may further include various other controls (power take-off (PTO) engagement, ignition, throttle, etc.) for operating the vehicle.

A pair of front ground-engaging members (e.g., a front left caster wheel 108a and a front right caster wheel 108b), which may be connected to forwardly extending portions of the chassis 102, may support a front portion of the vehicle 100 in rolling engagement with the ground surface 103. Although the illustrated vehicle 100 has the drive wheels 106 toward the rear of the chassis 102 and the caster wheels 108 toward the front, this configuration is not limiting. For example, other embodiments may reverse the location of the wheels, e.g., the drive wheels in front and the driven or undriven wheels in back. Moreover, other configurations may use different wheel configurations altogether, e.g., a tri-wheel configuration or a vehicle having conventionally-steered wheels. Still further, while illustrated herein as wheels, other ground-engaging members (e.g., tracks, skids, rollers, etc.) are also contemplated within the scope of this disclosure.

The mower may further include the cutting deck 104 mounted to a lower side of the chassis 102, e.g., generally between the drive wheels 106 and the caster wheels 108 (e.g., a “belly-mounted” deck). The cutting deck 104 may include a deck housing defining at least one downwardly-opening, partially enclosed cutting chamber. Within each cutting chamber may be contained one or more rotatable cutting blades, each attached to a rotatable blade spindle journaled to the deck housing. While illustrated herein as a belly-mounted deck, other mower configurations may, alternatively or in addition, utilize other deck configurations (e.g., an out-front or rear-mounted (e.g., towed) deck or a laterally-mounted deck). In addition, instead of rotary cutting decks, the cutting deck could instead be configured as one or more reel mower units, line cutting units, etc.

During operation, power may be selectively provided (e.g., by the prime mover 105) to at least one of the cutting deck 104 (e.g., to the blade spindles) and the drive wheels 106, whereby the cutting blades rotate at a speed sufficient to sever grass and other vegetation as the deck passes over the ground surface 103. Typically, the mower includes an operator-selectable height-of-cut control system to allow deck height adjustment relative to the ground surface 103.

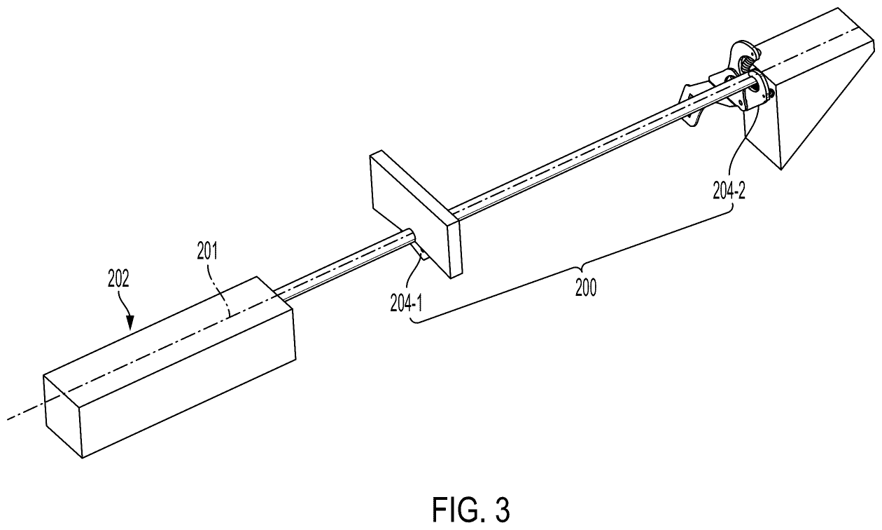

With this general overview of an exemplary vehicle 100, attachment systems in accordance with embodiments of the present disclosure are now described with reference to FIGS. 1-3. As shown in these figures, an exemplary attachment system 200 may be integrated with or operatively connected (directly or indirectly) to the chassis 102 of the vehicle 100. As described below, the system 200 is designed to receive and securely carry an item 202 during normal vehicle operation. The system 200 may include at least one receiver such as a first receiver 204-1 coupled to the vehicle 100 at a first location and a second receiver 204-2 coupled to the vehicle 100 at a second location (the receivers may be referred to herein collectively and individually as receiver(s) 204). The first and second receivers 204-1, 204-2 may be configured to receive and securely carry the item 202 as illustrated in FIG. 3. Alternatively, separate receivers may be configured to carry separate items. Accordingly, a single vehicle may be configured with a receiver or receivers for a single item, or with multiple receiver(s)/sets of receivers to permit simultaneous carrying of multiple items.

The receiver(s) 204 may carry one or more items 202 selected from a variety of items. For instance, the item 202 may be an elongate lawn maintenance tool such as a string trimmer, debris blower, shovel, rake, hoe, post hole digger, tamper, weeder, shears, pruner, saw, hammer, axe/hatchet, mallet, mattock, auger, etc., as well as recreational and hunting equipment. In fact, the receiver(s) 204 may receive most any item perceived as useful to the operator and/or to vehicle operation including, for instance, bucket bails, hearing protection, gloves, etc. While not wishing to be bound to any particular item, the item may be described and illustrated herein as a string trimmer 202 as perhaps best shown in FIG. 3, and the terms “string trimmer” and “item” may be used interchangeably herein without limitation.

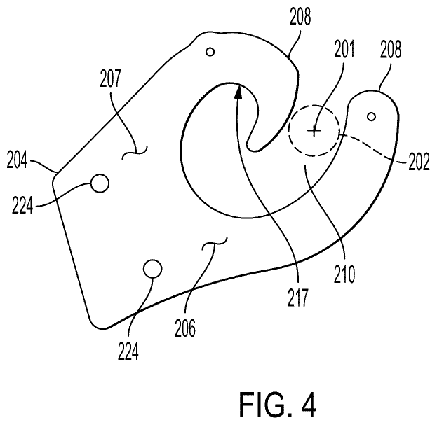

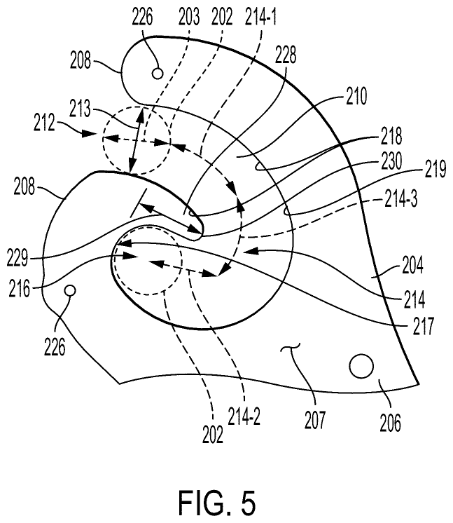

FIGS. 4-5 illustrate a receiver 204 in accordance with exemplary embodiments of the present disclosure. Each receiver 204 may be rigidly coupled to the vehicle 100/chassis 102 using most any suitable method (e.g., welds, fasteners, etc.). For instance, each receiver 204 may be mounted to the vehicle 100 using one or more fasteners via the provided holes 224.

While the shape of each receiver 204 may vary, it may in some embodiments form a flat, plate-like body 206 having one or more peripheral outer edges 208 and a slot 210, wherein the slot 210 extends from an interior or an interior portion of the body 206 outwardly through the outer edge 208 as illustrated in FIG. 4. Each receiver 204 may have a relatively shallow thickness or depth (dimension measured perpendicular to a face 207 of the body 206 (e.g., parallel to an axis 201 of the secured item 202)) when compared to a height and width of the body (wherein the height and width are measured in mutually orthogonal directions that are both orthogonal to the face 207/axis 201). Minimizing body/receiver depth may not only potentially reduce weight and cost, but may also reduce frictional resistance when inserting the item 202 into the receiver 204. Of course, the depth of each receiver 204 may vary depending on the particular vehicle and on the item being carried (e.g., the thickness may be increased to provide increased strength and rigidity for carrying heavier items).

As further illustrated in FIG. 4, each receiver 204 may include a curved or angled outer edge 208 (e.g., curved in the vicinity of an entrance or mouth of the slot 210), which may assist with guiding the item 202 into the slot. Providing such a smooth, curved outer edge 208 may also minimize wear to both the receiver 204 and the item 202 during insertion/removal of the item into/from the receiver.

With particular reference to FIG. 5, the slot 210 may form a mouth or mouth section 212 that extends through the outer edge 208. The mouth 212 may have a mouth width 213 that is sufficiently large to permit receipt of the item 202 for which the receiver was designed. The mouth width 213 may be defined as the diameter of the largest virtual cylinder (oriented with its axis orthogonal to the face 207) that may pass through the mouth 212 and into the slot 210. In practice, the mouth width 213 may be at least slightly larger than an effective cross sectional diameter 203 of the item 202 such that the item may pass with clearance into the slot 210. While not wishing to be bound to any particular size, the mouth width 213 may, in some embodiments, be between 0.5 inches and 2 inches, although greater (and lesser) widths are also contemplated.

In addition to the mouth 212, the slot 210 may include a seat or seat section 216. As shown in the figures, the seat 216 may include a seating surface 217 that forms a terminus of the slot 210 and furthermore is shaped to receive the item 202 in an abutting relationship once the item 202 is fully inserted into the receiver 204. The slot 210 may further include a throat or throat section 214 extending between and connecting the mouth and the seat.

As shown in FIGS. 4-5, the slot (e.g., the mouth 212, the throat 214, and the seat 216) may be formed by inner sidewalls 218, wherein at least one of the inner sidewalls defines a continuous curvilinear guiding surface 219 (see FIG. 5) extending from the mouth 212 to the seat 216. The continuous curvilinear guiding surface 219 may be configured as a surface that is devoid of abrupt changes in slope or other surface interruptions. Stated alternatively, the guiding surface 219 may be a smooth surface along which the item 202 may easily slide during insertion into and/or removal from the receiver 204. The shape of the guiding surface 219 may be selected to provide for simple, single-motion insertion/removal of the item 202 into/from the receiver 204. That is to say, an operator may insert the item 202 into the mouth 212 and push the item against the guiding surface 219. The item may then slide along the guiding surface 219 until it reaches the seating surface 217 of the seat 216. The item 202 may be removed from the receiver by moving the item in the reverse direction along the guiding surface.

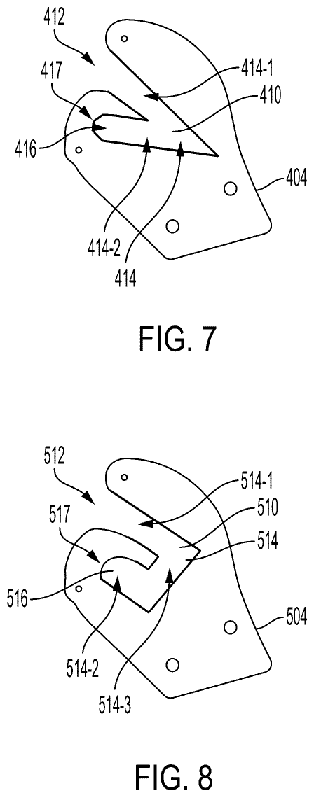

As illustrated in FIG. 5, the throat 214 may include a first throat portion 214-1 extending in a first direction from the mouth 212 towards the interior of the body 206. The throat 214 may further include a second throat portion 214-2 extending from the seat 216 also toward the interior of the body 206 in a second direction that is different than the first direction. The exemplary throat 214 may also include a third throat portion 214-3 extending from the first throat portion 214-1 to the second throat portion 214-2 in a third direction that is different than both the first and second directions. While shown in FIG. 5 as having these three distinct throat portions (214-1, 214-2, and 214-3), other embodiments may include only a first throat portion and a second throat portion (e.g., a V-shaped slot 410 like that shown in FIG. 7). In still other embodiments, additional throat portions could be provided to, for example, provide increased retention capability of the item 202 by the receiver 204.

As illustrated in FIGS. 4-5, a width of the slot 210 may optionally increase from the first throat portion 214-1 to the third throat portion 214-3 (e.g., to reduce frictional resistance). Moreover, the width of the slot 210 may decrease from the third throat portion 214-3 to the second throat portion 214-2 (e.g., to guide the item 202 against the seating surface 217).

The inner sidewalls 218 may further define a finger 228, which may extend into the throat 214 between the mouth 212 and the seat 216. The finger 228 may have a length 229 extending from a line tangent to an arc defining the seating surface 217 orthogonally to a tip 230 of the finger 228. In some embodiments, the length 229 of the finger 228 may be at least equal to half of the effective cross-sectional diameter 203 of the item 202. As a result, the finger 228 may assist with effectively holding the item 202 in the seat 216 (e.g., preventing movement of the item laterally to the slot). Of course, the length 229 of the finger may, in other embodiments, extend by a distance greater than half of the effective cross-sectional diameter 203 (as is indicated in FIG. 5). Such additional length of the finger 228 may further assist with item lateral retention.

Referring again to FIGS. 1-2, two identical receivers 204 may be provided on the vehicle 100 and configured to carry a single item. In the case of a tool having a straight, elongate construction like the string trimmer 202 shown, the two receivers 204 may be aligned (along the axis 201; see FIG. 3) with one another as shown. In alternative embodiments where the item has a nonlinear construction, the receivers 204 may be offset or otherwise mis-aligned with respect to one another in order to effectively receive and carry the item. In still other embodiments, the two receivers may be of different construction and/or shape. Alternatively, more or less receivers may be provided to accommodate different items. For example, a single receiver may be suitable for some items, while three or more receivers may be useful for others. While the material of the receiver(s) may vary depending on the particular application, it is contemplated that the receiver(s) 204 could be constructed from most any material including but not limited to metals and plastics. For example, in some embodiments each receiver may be made of acrylonitrile butadiene styrene (ABS). Such a material may assist with minimizing potential damage (e.g., scratching) to the item during insertion into/removal from the receiver.

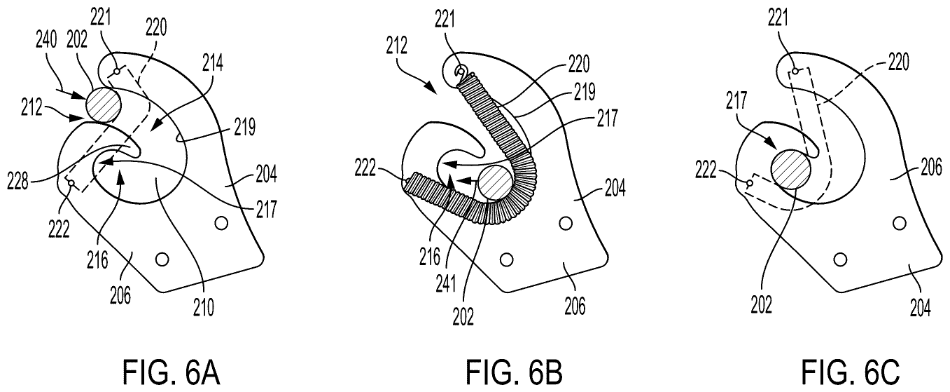

With reference now to FIGS. 6A-C, the attachment system 200 (e.g., each receiver 204) may further include at least one elastic member 220. The elastic member 220 may be, for example, a coiled extension spring (e.g., plastic-coated steel spring), or other elongate elastic material (e.g., rubber band). Alternatively or in addition, the elastic member 220 may include a surrounding sleeve (e.g., rubber tubular sleeve, not shown) configured to minimize wear to one or more of the item 202, elastic member 220, and receiver 204.

The elastic member 220 may include a first end 221 and a second end 222. The first and second ends 221, 222 may be coupled to the body 206 of the respective receiver 204 with fasteners via holes 226 (see FIG. 5). As shown in FIG. 6B, the first end 221 of the elastic member 220 may be coupled to the body 206 proximate the mouth 212 on a side opposite the finger 228, while the second end 222 of the elastic member may be coupled to the body proximate the seat 216 on a side also opposite of the finger. In general, the elastic member 220 may be coupled to the receiver 204 (and/or surrounding structure) in any manner that ensures the elastic member spans across both the mouth 212 and the seat 216 of the slot 210. In alternative embodiments, the elastic member 220 could be coupled to the receiver 204 (and/or surrounding structure) such that it spans across the mouth 212 but not necessarily across the seat 216 (e.g., extends from the “upper” hole 226 in FIG. 5 to a hole 226 on the finger 228). While the latter configuration may be suitable for lighter items, it may be unable to provide similar retention force as the illustrated elastic member attachment configuration.

To secure the item 202 in the receiver 204 (i.e., to move the item from a detached position outside the receiver to a secured position within), the operator may insert the item into the mouth 212 of the slot 210 as shown by the directional arrow 240 in FIG. 6A. As the item is pushed through the mouth 212 and into the throat 214 of the slot 210, the elastic member 220 elastically elongates from an initial position or length as the item presses against the elastic member. Further insertion of the item 202 causes the item to bear against the guiding surface 219 and further elongate the elastic member 220 (to a second position or length) as shown in FIG. 6B. Once the item 202 “bottoms out” in the throat 214, guiding surface 219 may cause the item to move toward the seat 216 (e.g., in the direction 241), wherein such motion is assisted by contraction of the elastic member 220 to a third position or length. That is to say, the elastic member 220 may elastically recover or contract, thus biasing the item 202 toward and eventually against the seating surface 217 (e.g., in the direction 241) as shown in FIG. 6C. Once seated, the biasing force of the elastic member 220 may press and hold the item 202 against the seating surface 217. The characteristics of the elastic member may be selected based upon the particular item (e.g., item weight) and the estimated acceleration that the item may experience during typical vehicle operation.

To release the item 202 from the seating surface 217 of the seat 216, a threshold force is applied sufficient to overcome the biasing force of the elastic member 220, allowing the item to move along the guiding surface 219 and into the throat 214. Once the item reaches the bottom of the throat 214, the elastic member 220 may contract and assist in ejecting the item 202 from the slot 210 through the mouth 212.

As one of skill may appreciate, the combination of the elastic member 220 and the guiding surface 219 may allow for a simplistic, single-motion movement of the item into and out of the receiver 204. However, other embodiments of the present disclosure may provide the desired insertion and retention capabilities without providing a continuous guiding surface like the surface 219. For instance, FIG. 7 illustrates a receiver 404 having a slot 410/throat 414 that form a V-shape, where a first throat portion 414-1 (extending from a mouth 412) and a second throat portion 414-2 (extending to a seat 416) intersect at an acute angle to one another (e.g., no third throat portion equivalent to the throat portion 214-3 is provided). Thus, instead of having the smooth guiding surface to assist with insertion/removal of the item 202, the receiver 404 may requires the operator to push the item 202 against the elastic member (not shown) until reaching an apex or bottom of the V-shaped slot, and then guide the item into the second throat portion 414-2 until reaching the seating surface 417 of the seat 416.

In a similar manner, FIG. 8 illustrates a receiver 504 having a U-shaped slot 510 with a mouth 512 and throat 514 that defines a U-shape, where first and third throat portions 514-1, 514-3 form an approximately 90 degree angle, and where a second and the third throat portion 514-2, 514-3 form another approximately 90 degree angle as shown, wherein the second portion 514-2 terminates at a seating portion 517 of a seat 516. Again, the receiver 504 may require the operator to shift directional movement of the item within the slot 510 during item insertion/removal.

Other than these distinctions, the embodiments of FIGS. 7 and 8 may allow the item 202 (not shown) to be inserted and secured in the respective seat of the receiver in a manner similar to the receiver 204 (e.g., using an elastic member 220). Accordingly, a separate description of operation of the receivers 404 and 504 is not provided herein.

As one of skill in the art may appreciate, retainers having other slot geometries are certainly possible within the scope of this disclosure. For example, other retainers may include a J-shaped or Z-shaped slot, or most any other slot shape that provides a nonlinear path between the mouth and the seat.

While described herein as being incorporated onto a utility vehicle, other applications are certainly contemplated. For example, attachments systems in accordance with embodiments of the present disclosure may be used in static applications without departing from the scope of this disclosure. For example, one or more receivers like those described and illustrated herein could be mounted to a fixed or other non-vehicular surface (e.g., an interior or exterior wall of a garage, shed, or other surface of a home or storage building) to receive items during storage. As stated above, such static applications may utilize a single receiver or two or more receivers depending on the item to be stored.

In still other embodiments, an attachment system (e.g., one or more receivers) in accordance with embodiments of the present disclosure could be mounted to a fixed surface (e.g., wall/floor surface of a garage or transport trailer) such that the mouth of each receiver is positioned to engage a transversely extending cross bar (i.e., “item”) attached to an end (e.g., front end) of a vehicle (e.g., walk behind lawn mower). As a result, the vehicle may be advanced toward the receivers such that the cross bar (and thus the vehicle) engages the mouth of the receivers and then moves along the slot until the mower is ultimately secured in the receiver seats as already described herein. This permits the vehicle to be secured in place (e.g., in a garage or on a trailer) for storage or transport. The vehicle could be removed from the attachment system by manipulating (lifting the front end of) the vehicle to effectively withdraw the cross bar from the receivers in a manner already described herein. Alternatively, the receivers (e.g., the body of each receiver) could unlock and selectively pivot (e.g., about a horizontal axis) to assist with removal of the cross bar from the attachment system. While the cross bar and receivers are described as being located on the mower and fixed surface, respectively, the positions of these components could be switched without adversely affecting functionality.

Illustrative embodiments are described, and reference has been made to possible variations of the same. These and other variations, combinations, and modifications will be apparent to those skilled in the art, and it should be understood that the claims are not limited to the illustrative embodiments set forth herein.

What is claimed is:

1. An attachment system configured to carry an item on a utility vehicle comprising:
at least one receiver, the receiver comprising:
a body having a peripheral outer edge and inner sidewalls, the inner sidewalls defining a slot that extends from an interior of the body through the outer edge, wherein the slot defines:
a mouth extending through the outer edge;
a seat configured to receive the item when the item is carried by the utility vehicle; and
a throat extending between and connecting the mouth and the seat; and
at least one elastic member, the elastic member comprising a first end and a second end, wherein the first and second ends are coupled to the body and the elastic member extends across the mouth, and wherein the elastic member is configured to releasably secure the item within the seat.

2. The attachment system of claim 1, wherein one or more of the inner sidewalls defines a continuous curvilinear guiding surface extending from the mouth to the seat.

3. The attachment system of claim 1, wherein the throat comprises:
a first throat portion extending from the mouth towards the interior of the body in a first direction; and
a second throat portion extending from the first throat portion towards the seat in a second direction that is different than the first direction.

4. The attachment system of claim 3, wherein the throat further comprises a third throat portion extending between the first and second throat portions in a third direction that is different than both the first and second directions.

5. The attachment system of claim 1, wherein the first end of the elastic member is coupled to the body proximate the mouth, and wherein the second end of the elastic member is coupled to the body proximate the seat.

6. The attachment system of claim 1, wherein the elastic member is configured to elastically elongate from an initial position as the item is inserted into the mouth, to a second position as the item is positioned in the throat, and wherein the elastic member is configured to partially elastically recover from the second position to a third position when the item is releasably secured in the seat.

7. The attachment system of claim 1, wherein the inner sidewalls define a finger extending into the throat between the mouth and the seat, and wherein the finger has a length that is equal to or greater than an effective cross-sectional diameter of the item when the item is positioned within the seat.

8. The attachment system of claim 1, wherein the at least one receiver comprises a first receiver coupled to the utility vehicle at a first location and a second receiver coupled to the utility vehicle at a second location, and wherein the first and second receivers are configured to simultaneously receive the item.

9. A utility vehicle comprising:
a chassis;
wheels configured to support the chassis in rolling engagement with a ground surface; and
an attachment system configured to carry an item on the vehicle, the attachment system comprising:
at least one receiver secured to the chassis, the receiver comprising:
a body having a peripheral outer edge and inner sidewalls, the inner sidewalls defining a slot that extends from an interior of the body through the outer edge, wherein the slot defines:
a mouth extending through the outer edge;
a seat configured to receive the item when the item is carried by the vehicle; and
a throat extending between and connecting the mouth and the seat; and
at least one elastic member, the elastic member comprising a first end and a second end, wherein the first and second ends are coupled to the body and the elastic member extends across the mouth, and wherein the elastic member is configured to releasably secure the item within the seat.

10. The vehicle of claim 9, wherein the vehicle comprises at least one of an all-terrain vehicle, a utility task vehicle, and a ground maintenance or work vehicle.

11. The vehicle of claim 9, wherein the at least one receiver comprises a first receiver and a second receiver.

12. The vehicle of claim 11, wherein the first and second receivers are aligned with one another such that they may simultaneously support the item.

13. The vehicle of claim 9, wherein the mouth is configured to receive an item having an effective cross-sectional diameter between 0.5 inches and 2 inches.

14. A method for moving an item from a detached position to a secured position within a receiver, wherein the method comprises:
inserting the item into a mouth of a slot formed in the receiver;
advancing the item into a throat of the slot; and
positioning the item within a seat of the slot,
wherein an elastic member is coupled to the receiver and extends across the mouth and the seat, and wherein the elastic member is configured to elongate as the item moves into the throat of the slot, and contract as the item moves into the seat.
